(19) United States
(12) Patent Application Publication
(10) Pub. No.: US 2021/0016795 A1
(43) Pub. Date: Jan. 21, 2021

(54) VEHICLE CONTROLLER DEVICE

(71) Applicant: TOYOTA JIDOSHA KABUSHIKI KAISHA, Toyota-shi (JP)

(72) Inventors: Makoto MATSUSHITA, Ichinomiya-shi (JP); Atsushi HANAWA, Miyoshi-shi (JP); Yasuki NAKAGAWA, Toyota-shi (JP); Yusuke YOKOTA, Susono-shi (JP); Tomoyuki KURIYAMA, Hadano-shi (JP); Tae SUGIMURA, Miyoshi-shi (JP)

(73) Assignee: TOYOTA JIDOSHA KABUSHIKI KAISHA, Toyota-shi (JP)

(21) Appl. No.: 16/884,555

(22) Filed: May 27, 2020

(30) Foreign Application Priority Data
Jul. 17, 2019 (JP) 2019-132161

(51) Int. Cl. B60W 60/00; B60W 50/14; B60W 50/12

(52) U.S. Cl. CPC B60W 60/005; B60W 60/001; B60W 50/12; B60W 50/14

(57) ABSTRACT

A vehicle controller device includes a processor. The processor is configured to control autonomous driving in which the vehicle travels based on a travel plan, and to control remote driving in which the vehicle travels based on operation information received by a communication section. The processor is further configured to output information relating to a driving state corresponding to manual driving by operation by an occupant of the vehicle, autonomous driving, or remote driving, and information relating to a transitional state corresponding to a transition from one driving state to another driving state, to a notification unit configured to perform notification of the driving state and the transitional state.

### CROSS-REFERENCE TO RELATED APPLICATION

This application is based on and claims priority under 35 USC 119 from Japanese Patent Application No. 2019-132161 filed on Jul. 17, 2019, the disclosure of which is incorporated by reference herein.

### BACKGROUND

### Technical Field

The present disclosure relates to a vehicle controller device capable of autonomous driving and remote driving.

### Related Art

Japanese Patent Application Laid-Open (JP-A) No. 2018-77649 discloses a vehicle that is capable of traveling in driving states including manual driving operated by a vehicle occupant, autonomous driving in which the vehicle travels independently, and remote driving performed by a remote operator operating a remote operation station.

In the vehicle disclosed in JP-A No. 2018-77649, from a safety perspective it would be desirable for the occupant and the surroundings of the vehicle to be notified of information relating to the driving state and to a transition from one driving state to another driving state.

### SUMMARY

In consideration of the above circumstances, the present disclosure is to provide a vehicle controller device capable of notifying information relating to a driving state and to a transition from one driving state to another driving state.

A vehicle controller device according to a first aspect of the present disclosure includes a communication section configured to receive operation information for operating a vehicle from an operation device external to the vehicle, an acquisition section configured to acquire peripheral information regarding a periphery of the vehicle from a peripheral information detection section, a travel plan generation section configured to generate a travel plan for the vehicle based on the peripheral information, a travel control section configured to control autonomous driving in which the vehicle travels in accordance with the travel plan generated by the travel plan generation section, and control remote driving in which the vehicle travels in accordance with the operation information received by the communication section, and a notification section configured to output information relating to a driving state corresponding to manual driving by operation by an occupant of the vehicle, the autonomous driving, or the remote driving, and information relating to a transitional state corresponding to a transition from one driving state to another driving state, to a notification unit configured to perform notification of the driving state and the transitional state.

The vehicle controller device according to the first aspect of the present disclosure is capable of implementing the manual driving by operation by the occupant of the vehicle, the autonomous driving in which travel is based on the travel plan generated in the vehicle controller device, and the remote driving by the operation device.

The vehicle controller device outputs information relating to these driving states as well as information regarding the transitional state corresponding to a transition from one of the driving states to another of the driving states to the notification unit. This enables the notification unit to perform notification of information relating to the respective driving states and the transitional state.

A vehicle controller device according to a second aspect of the present disclosure is the configuration of the first aspect, wherein the transitional state is a state corresponding to a period of time from a start to an end of control performed in the vehicle to transition from one driving state to another driving state, and the notification unit is configured to switch from performing notification of the driving state to performing notification of the transitional state in conjunction with commencement of the control of the transition.

In the vehicle controller device according to the second aspect of the present disclosure, notification of the driving state is switched to notification of the transitional state at the start of the control to transition from the one driving state to the other driving state in the vehicle. The notification unit is thus capable of clearly notifying of the switch between driving states of the vehicle, and is thus capable of prompting care to be taken when transitioning between driving states.

A vehicle controller device according to a third aspect of the present disclosure is the configuration of either the first aspect or the second aspect, wherein in a case in which a transition from one driving state to another driving state is scheduled, the transitional state includes a period of time from when the transition from the one driving state to the other driving state becomes imminent until commencement of the transition, and the notification unit is configured to switch from performing notification of the driving state to performing notification of the transitional state when the transition has become imminent.

In the vehicle controller device according to the third aspect of the present disclosure, in cases in which a transition from one driving state to another driving state is scheduled, notification of the driving state is switched to notification of the transitional state when the transition has become imminent. For example, in cases in which travel in a predetermined driving state is scheduled for a segment of a travel route to a destination, advance notification of this forthcoming driving state transition can be performed. This enables the occupant or the vehicle surroundings to be prompted to take care from an early stage, thus improving safety during travel.

A vehicle controller device according to a fourth aspect of the present disclosure is the configuration of any one of the first aspect to the third aspect, wherein the notification unit is configured to perform notification of the driving state and the transitional state using mutually different notification modes.

In the vehicle controller device according to the fourth aspect of the present disclosure, notification of the respective driving states and the transitional state is performed using mutually different notification modes. For example, this enables notification of a state that is important from the perspective of travel safety to be performed using a notification mode that draws the attention of the occupant or the vehicle surroundings more strongly than other notifications, thus prompting appropriate caution. This enables public traffic safety to be improved.

A vehicle controller device according to a fifth aspect of the present disclosure is the configuration of any one of the first aspect to the fourth aspect, wherein the notification unit is provided inside the vehicle, and is configured to perform notification of the driving state and the transitional state in response to a request by an occupant inside the vehicle.

In the vehicle controller device according to the fifth aspect of the present disclosure, information relating to the driving state or transitional state is notified using the notification unit provided inside the vehicle. Notification of these states is performed when a request has been made by the occupant. Since the occupant is notified of information relating to the respective driving states and the transitional state as and when it is necessary to do so, both safety and relaxation during travel can be improved.

A vehicle controller device according to a sixth aspect of the present disclosure is the configuration of any one of the first aspect to the fourth aspect, wherein the notification unit is provided facing outward from the vehicle, and is configured to perform notification of the driving state and the transitional state in a manner enabling another vehicle or person to perceive the driving state and the transitional state.

In the vehicle controller device according to the sixth aspect of the present disclosure, another vehicle or person is notified of the information relating to the driving state or transitional state by the notification unit provided facing outward from the vehicle. The notification unit is thus capable of notifying other vehicles and pedestrians in the surroundings of the vehicle of information relating to the driving state or the transitional state.

A vehicle controller device according to a seventh aspect of the present disclosure is the configuration of any one of the first aspect to the sixth aspect, wherein the communication section is configured to transmit information relating to the driving state or the transitional state to another vehicle in a peripheral area of the vehicle.

In the vehicle controller device according to the seventh aspect of the present disclosure, information relating to the driving state or the transitional state is transmitted to another vehicle in the surroundings of the vehicle, for example by using inter-vehicle communication. This enables the other vehicle to receive accurate notification of the information relating to the driving state or the transitional state, even in situations in which it is difficult to confirm the circumstances of the vehicle from the other vehicle, for example when traveling at night or in bad weather.

The vehicle controller device of the first aspect of the present disclosure exhibits the excellent advantageous effect of enabling information relating to the driving state or relating to a transition from one driving state to another driving state to be notified using the notification unit.

The vehicle controller device of the second aspect of the present disclosure exhibits the excellent advantageous effect of enabling the switch between driving states of the vehicle to be clearly notified using the notification unit, thus enabling care to be prompted when transitioning between driving states.

The vehicle controller device of the third aspect of the present disclosure exhibits the excellent advantageous effect of enabling the occupant and surroundings of the vehicle to be prompted to take care from an early stage, thus enabling travel safety to be improved.

The vehicle controller device of the fourth aspect of the present disclosure exhibits the excellent advantageous effect of enabling public traffic safety to be improved.

The vehicle controller device of the fifth aspect of the present disclosure exhibits the excellent advantageous effect enabling both safety and relaxation during travel to be improved.

The vehicle controller device of the sixth aspect of the present disclosure exhibits the excellent advantageous effect of enabling other vehicles and pedestrians in the surroundings of the vehicle to be notified of information relating to the driving states and the transitional state by the notification unit.

The vehicle controller device of the seventh aspect of the present disclosure exhibits the excellent advantageous effect of enabling the other vehicle to receive accurate notification of the information relating to the driving state or the transitional state, even in situations in which it is difficult to confirm the circumstances of the vehicle from the other vehicle, for example when traveling at night or in bad weather.

### BRIEF DESCRIPTION OF THE DRAWINGS

Exemplary embodiments of the present disclosure will be described in detail based on the following figures, wherein:

FIG. 1 is a diagram illustrating schematic configuration of a vehicle control system according to a first exemplary embodiment;

FIG. 2 is a block diagram illustrating hardware configuration of a vehicle in the first exemplary embodiment;

FIG. 3 is a block diagram illustrating an example of functional configuration of a vehicle controller device in the first exemplary embodiment;

FIG. 4 is a flowchart explaining a flow of transition processing by a vehicle controller device;

FIG. 5 is a flowchart explaining a flow of notification processing by a vehicle controller device;

FIG. 6 is a schematic diagram explaining an example of notification modes based on the notification processing illustrated in FIG. 5;

FIG. 7 is a flowchart explaining a flow of notification processing by a vehicle controller device according to a second exemplary embodiment; and

FIG. 8 is a schematic diagram explaining an example of notification modes based on the notification processing illustrated in FIG. 7.

### DETAILED DESCRIPTION

### First Exemplary Embodiment

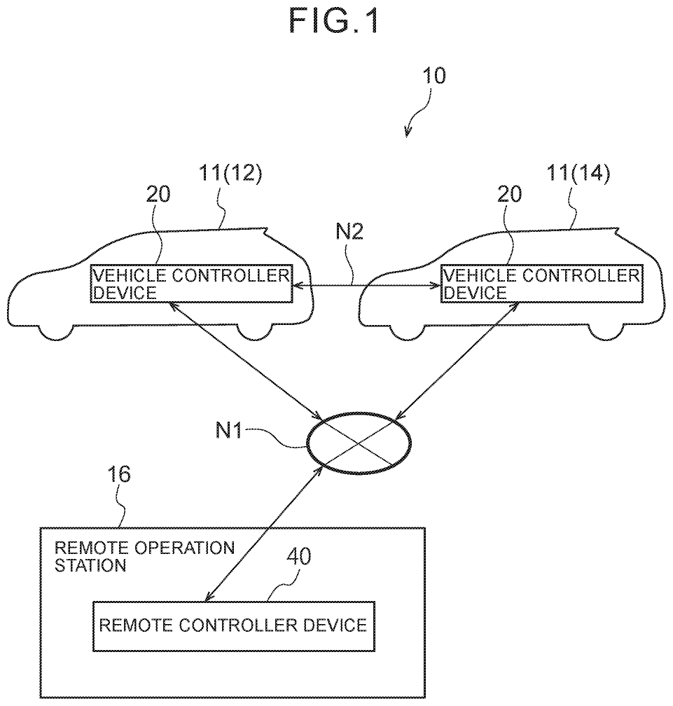

FIG. 1 is a block diagram illustrating schematic configuration of a vehicle control system 10 according to a first exemplary embodiment.

Outline

As illustrated in FIG. 1, the vehicle control system 10 according to the present exemplary embodiment is configured including autonomous driving-enabled vehicles 11 and a remote operation station 16 serving as an operation device. In the present exemplary embodiment, the autonomous driving-enabled vehicles 11 include a given vehicle 12 serving as a vehicle, and another vehicle 14 serving as another vehicle.

The given vehicle 12 and the other vehicle 14 of the present exemplary embodiment each include a vehicle controller device 20. The remote operation station 16 includes a remote controller device 40. In the vehicle control system 10, the vehicle controller device 20 of the given vehicle 12, the vehicle controller device 20 of the other vehicle 14, and the remote controller device 40 of the remote operation station 16 are connected to each other through a network N1. The respective vehicle controller devices 20 are also capable of communicating directly with each other using inter-vehicle communication N2.

Note that although the vehicle control system 10 in FIG. 1 includes two autonomous driving-enabled vehicles (the vehicles 12, 14) and a single remote operation station 16, there is no limitation thereto. The vehicle control system 10 may include three or more of the autonomous driving-enabled vehicles, and may include two or more of the remote operation stations 16.

The given vehicle 12 is configured so as to be capable of implementing autonomous driving in which travel is performed independently based on a pre-generated travel plan, remote driving based on operation of the remote operation station 16 by a remote driver (or operator), and manual driving based on operation by an occupant (driver) of the given vehicle 12. Note that similarly to the given vehicle 12, the vehicle controller device 20 of the other vehicle 14 is also capable of implementing autonomous driving, remote driving, and manual driving.

In the following explanation, autonomous driving, remote driving, and manual driving configure driving states of the given vehicle 12. A transitional state of the given vehicle 12 persists from the beginning to the end of transition processing to control a transition of the given vehicle 12 from one driving state to another driving state. Note that the transition processing is described in detail later.

Autonomous Driving-Enabled Vehicle

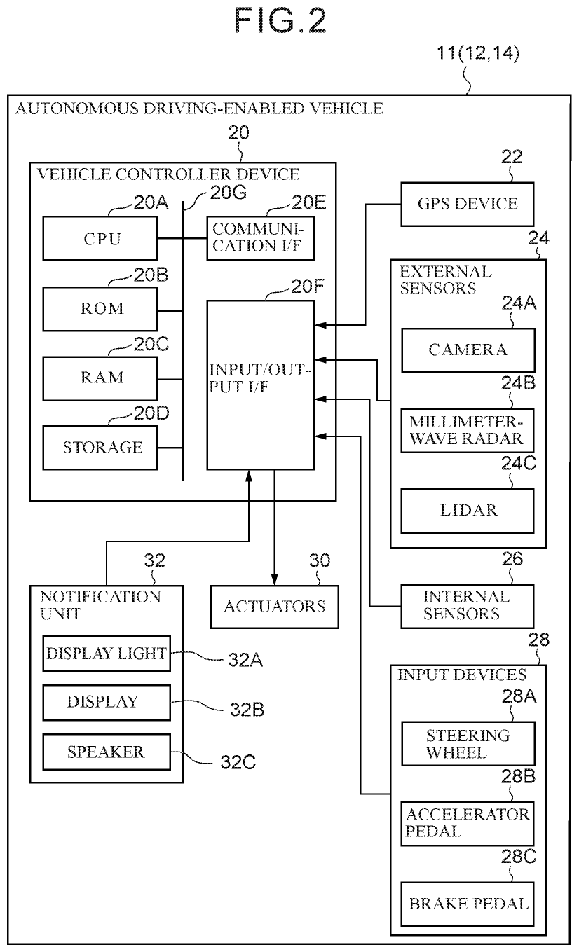

FIG. 2 is a block diagram illustrating hardware configuration of equipment installed in the given vehicle 12 of the present exemplary embodiment. Note that since the other vehicle 14 has a similar configuration, explanation will be given regarding the given vehicle 12 only. In addition to the vehicle controller device 20 described above, the given vehicle 12 includes a global positioning system (GPS) device 22, external sensors 24, internal sensors 26, input devices 28, actuators 30, and notification unit 32.

The vehicle controller device 20 is configured including a central processing unit (CPU) 20A, read only memory (ROM) 20B, random access memory (RAM) 20C, storage 20D, a communication interface (I/F) 20E, and an input/output I/F 20F. The CPU 20A, the ROM 20B, the RAM 20C, the storage 20D, the communication I/F 20E and the input/output I/F 20F are connected together so as to be capable of communicating with each other through a bus 20G The CPU 20A is an example of a processor, and the RAM 20C is an example of memory.

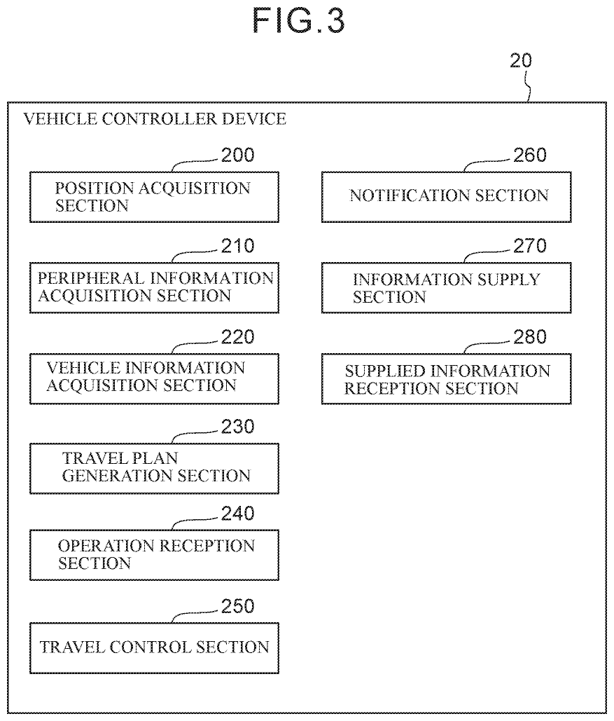

The CPU 20A is a central processing unit that executes various programs and controls various sections. Namely, the CPU 20A reads a program from the ROM 20B and executes the program, using the RAM 20C as a workspace. In the present exemplary embodiment, an execution program is stored in the ROM 20B. When the CPU 20A executes the execution program, the vehicle controller device 20 functions as a position acquisition section 200, a peripheral information acquisition section 210, a vehicle information acquisition section 220, a travel plan generation section 230, an operation reception section 240, a travel control section 250, a notification section 260, an information supply section 270, and a supplied information reception section 280, as illustrated in FIG. 3.

The ROM 20B illustrated in FIG. 2 stores various programs and various data. The RAM 20C serves as a workspace to temporarily store the programs or data.

The storage 20D serves as a storage section, is configured by a hard disk drive (HDD) or a solid state drive (SSD), and stores various programs including an operating system, as well as various data.

The communication I/F 20E serves as a communication section, and includes an interface for connecting to the network N1 in order to communicate with other vehicle controller devices 20, the remote controller device 40, a non-illustrated information server, and the like. A communication protocol such as Long Term Evolution (LTE) or Wi-Fi (registered trademark) is employed as the interface. Moreover, the communication I/F 20E includes a wireless device to communicate directly with the other vehicle controller devices 20 using the inter-vehicle communication N2.

The communication I/F 20E of the present exemplary embodiment transmits an image captured by a camera 24A to the remote operation station 16 that is external to the given vehicle 12, and receives operation information for operating the given vehicle 12 from the remote operation station 16, through the network N1. The communication I/F 20E also transmits risk information to the other vehicle 14, this being another vehicle, using the inter-vehicle communication N2 employing Dedicated Short Range Communications (DSRC) or the like. Note that the communication I/F 20E may also receive weather information, earthquake information, and traffic information regarding traffic jams, accidents, roadworks, and so on from an external information server through the network N1.

The input/output I/F 20F is an interface for communicating with the respective devices installed in the given vehicle 12. The GPS device 22, the external sensors 24, the internal sensors 26, the input devices 28, the actuators 30, and the notification unit 32 are connected to the vehicle controller device 20 of the present exemplary embodiment through the input/output I/F 20F. Note that the GPS device 22, the external sensors 24, the internal sensors 26, the input devices 28, the actuators 30, and the notification unit 32 may be directly connected to the bus 20G.

The GPS device 22 is a device for measuring the current position of the given vehicle 12. The GPS device 22 includes an antenna (not illustrated in the drawings) to receive signals from GPS satellites.

The external sensors 24 serve as a peripheral information detection section, and are a group of sensors that detect information regarding the surroundings of the given vehicle 12. The external sensors 24 include the camera 24A that images a predetermined range, millimeter-wave radar 24B that transmits scanning waves over a predetermined range and receives the reflected waves, and laser imaging detection and ranging (LIDAR) 24C that scans a predetermined range.

The internal sensors 26 are a group of sensors that detect travel states of the given vehicle 12. The internal sensors 26 include at least one out of a vehicle speed sensor, an acceleration sensor, or a yaw rate sensor.

The input devices 28 are a group of switches operated by the occupant on board the given vehicle 12. The input devices 28 include a steering wheel 28A serving as a switch to steer the steered wheels of the given vehicle 12, an accelerator pedal 28B serving as a switch to cause the given vehicle 12 to accelerate, and a brake pedal 28C serving as a switch to cause the given vehicle 12 to decelerate.

The actuators 30 include a steering wheel actuator to drive the steered wheels of the given vehicle 12, an accelerator actuator to control acceleration of the given vehicle 12, and a brake actuator to control deceleration of the given vehicle 12.

The notification unit 32 is an output interface provided inside the vehicle in order to perform notification of a driving state or a transitional state of the given vehicle 12. The notification unit 32 notifies the vehicle occupant using various notification modes in response to information output by the notification section 260, described later. The notification unit 32 of the present exemplary embodiment is configured by a display light 32A, a display 32B, and a speaker 32C provided inside the vehicle.

FIG. 3 is a block diagram illustrating an example of functional configuration of the vehicle controller device 20. As illustrated in FIG. 3, the vehicle controller device 20 includes the position acquisition section 200, the peripheral information acquisition section 210, the vehicle information acquisition section 220, the travel plan generation section 230, the operation reception section 240, the travel control section 250, the notification section 260, the information supply section 270, and the supplied information reception section 280. Each of these functional configurations is implemented by the CPU 20A reading the execution program stored in the ROM 20B, and executing this program.

The position acquisition section 200 includes functionality to acquire the current position of the given vehicle 12. The position acquisition section 200 acquires position information from the GPS device 22 through the input/output I/F 20F.

The peripheral information acquisition section 210 serves as an acquisition section, and includes functionality to acquire peripheral information peripheral to the given vehicle 12. The peripheral information acquisition section 210 acquires the peripheral information regarding the given vehicle 12 from the external sensors 24 through the input/output I/F 20F. The “peripheral information” includes not only information regarding other vehicles and pedestrians in the surroundings of the given vehicle 12, but also information regarding the weather, brightness, road width, obstacles, and so on.

The vehicle information acquisition section 220 includes functionality to acquire vehicle information such as the vehicle speed, acceleration, yaw rate, and so on of the given vehicle 12. The vehicle information acquisition section 220 acquires the vehicle information regarding the given vehicle 12 from the internal sensors 26 through the input/output I/F 20F.

The travel plan generation section 230 includes functionality to generate a travel plan to cause the given vehicle 12 to travel based on the position information acquired by the position acquisition section 200, the peripheral information acquired by the peripheral information acquisition section 210, and the vehicle information acquired by the vehicle information acquisition section 220. The travel plan includes not only a travel route to a pre-set destination, but also information regarding a course to avoid obstacles ahead of the given vehicle 12, the speed of the given vehicle 12, and so on.

The travel plan generation section 230 also includes functionality to set the driving state of the given vehicle 12 for a predetermined segment of a travel route from the current location to a destination. For example, when travel in one driving state is restricted in a predetermined segment for reasons such as legal restrictions, bad weather, traffic regulations, or congestion, the most appropriate alternative driving state is set as the driving state. Alternatively, setting may be made such that the given vehicle 12 travels in one driving state in a predetermined segment in response to a request by the occupant of the given vehicle 12.

The operation reception section 240 includes functionality to receive signals output from the various input devices 28 when manual driving is being performed based on operation by the occupant of the given vehicle 12. The operation reception section 240 also generates vehicle operation information, this being operation information for controlling the actuators 30, based on signals received from the various input devices 28.

The travel control section 250 includes functionality to control autonomous driving based on the travel plan generated by the travel plan generation section 230, remote driving based on the operation information received from the remote operation station 16, and manual driving based on the operation information received from the operation reception section 240. The travel control section 250 also includes functionality to control the given vehicle 12 according to the transition processing, described later, so as to cause the given vehicle 12 to transition from one driving state to another driving state. The given vehicle 12 is in the transitional state for a period of time spanning from input of a start command to start the transition processing to input of an end command to end the transition processing.

The notification section 260 includes functionality to output the current driving state of the given vehicle 12 and information relating to the transitional state to the notification unit 32.

The notification section 260 determines the current driving state or transitional state of the given vehicle 12 based on information acquired from the travel control section 250, and outputs information relating to this state to the notification unit 32. The notification section 260 also includes functionality to output information relating to the driving state or transitional state in cases in which a request has been made by the occupant. Specifically, the notification section 260 switches a notification flag ON and OFF based on operation information from the occupant using a non-illustrated input interface provided inside the vehicle, and outputs to the notification unit 32 under a condition of the notification flag being ON.

The notification section 260 may also be configured to store information relating to the driving state or transitional state associated with the travel route in the storage 20D. The information stored in the storage 20D can be utilized in the event of vehicle trouble in order to pinpoint the agent that was operating the vehicle when the trouble occurred.

The information supply section 270 includes functionality to supply information relating to the driving state or transitional state of the given vehicle 12, this being the given vehicle, to other vehicles installed with a vehicle controller device 20. In the present exemplary embodiment, the information supply section 270 of the given vehicle 12 is able to transmit information relating to the driving state or transitional state output by the notification section 260 to the other vehicle 14 using the inter-vehicle communication N2.

The supplied information reception section 280 includes functionality to receive information relating to a driving state or transitional state transmitted from another vehicle installed with a vehicle controller device 20 through the communication I/F 20E.

Control Flow

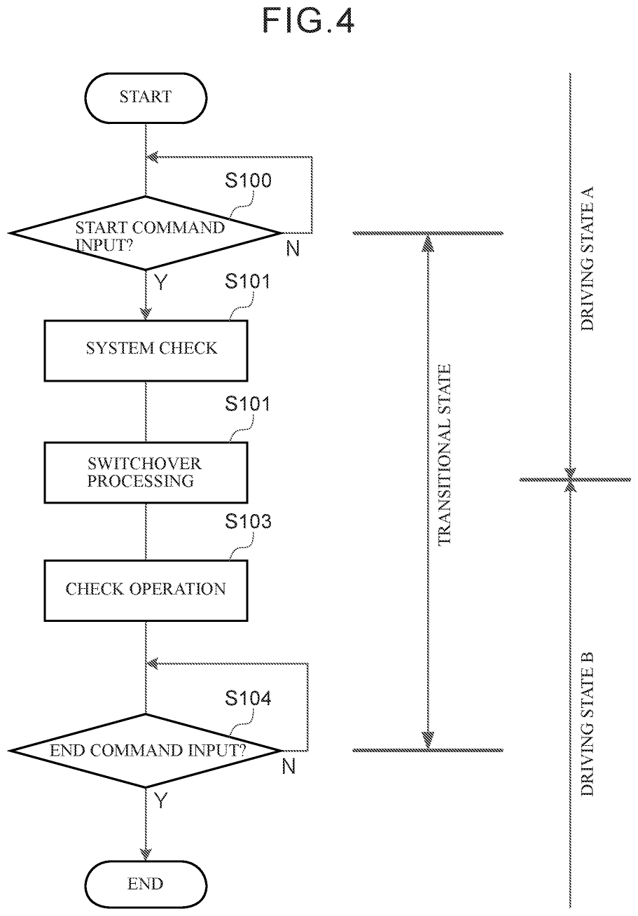

The transition processing is executed in the vehicle controller device 20 of the present exemplary embodiment in order to transition between driving states. Explanation follows regarding a flow of the transition processing, with reference to the flowchart in FIG. 4. FIG. 4 explains a flow of transition processing for a transition from a driving state A, this being one driving state, to a driving state B, this being another driving state.

At step S100 in FIG. 4, the CPU 20A determines whether or not a start command instructing the start of transition processing has been input. Processing proceeds to step S101 in cases in which the CPU 20A determines that a start command has been input. The processing of step S100 is repeated in cases in which determination is made that the start command has not been input.

Note that the start command may be input according to operation information from the occupant operating a non-illustrated operation section, or may be input according to a travel plan generated by the travel plan generation section 230. Alternatively, the start command may be input according to operation information from the remote operation station 16.

At step S101, the CPU 20A confirms that the various systems pertinent to the post-transition driving state B are operating well. For example, in cases in which the given vehicle 12 is to transition to manual driving, the CPU 20A confirms that there is a good connection state between the vehicle controller device 20 and the input devices 28. In cases in which a transition is to be made to autonomous driving, the CPU 20A confirms that the actuators 30 are operating well. In cases in which a transition is to be made to remote driving, the CPU 20A confirms whether there is a good communication state with the remote operation station 16.

At step S102, the CPU 20A switches the given vehicle 12 from the driving state A to the driving state B. In the present exemplary embodiment, this switch may be made between any out of manual driving, autonomous driving, or remote driving. The operation agents of the given vehicle 12 before and after this switch are different.

At step S103, the CPU 20A performs a driving state switchover operation check. Namely, the CPU 20A monitors for normal travel of the given vehicle 12 in the driving state B for a predetermined duration based on information acquired from the travel control section 250.

At step S104, the CPU 20A determines whether or not an end command instructing the end of transition processing has been input. The transition processing is ended in cases in which determination is made that the end command has been input. The processing of step S104 is repeated in cases in which determination is made that the end command has not been input.

Note that the end command may be input according to operation information from the occupant operating the operation section to indicate that a travel state has been confirmed after having transitioned to the driving state. Alternatively, in cases in which a timer is started at step S104 and no driving problems are confirmed within a predetermined duration, the end command may be input according to an instruction from the vehicle controller device 20 once the predetermined duration has elapsed.

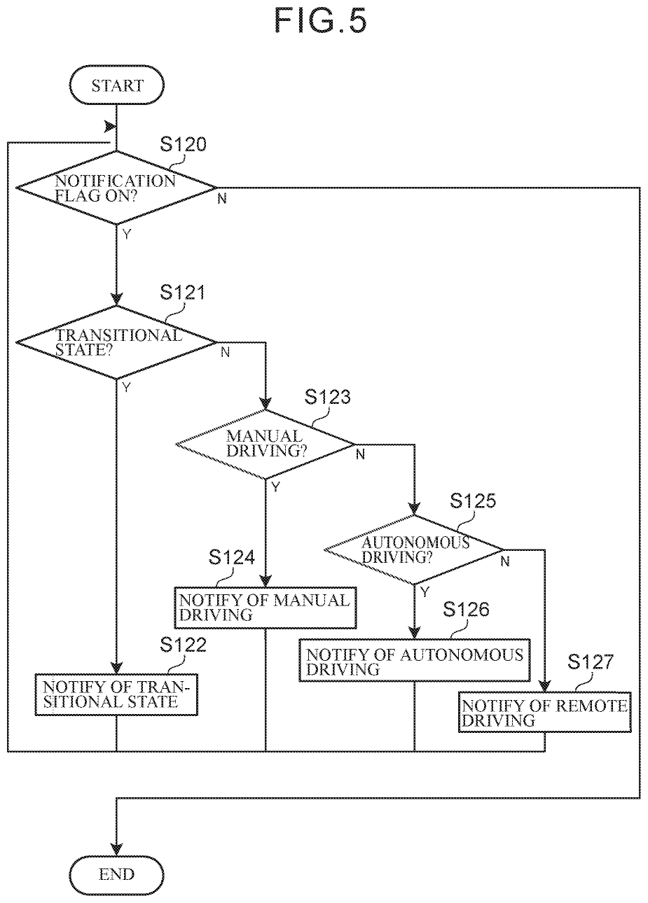

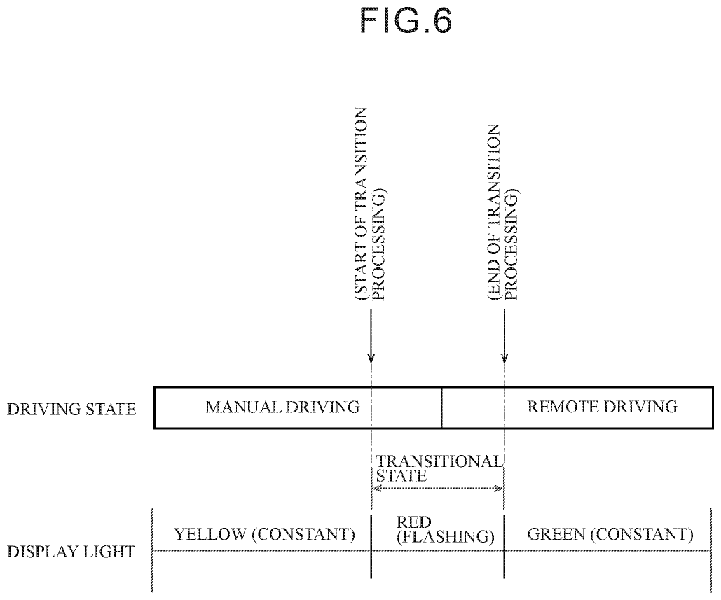

Explanation follows regarding a flow of notification processing executed by the vehicle controller device 20, with reference to the flowchart in FIG. 5. The notification processing is executed in order to notify the vehicle occupant and nearby vehicles of information relating to the driving state or transitional state of the given vehicle 12. Note that FIG. 6 is a schematic diagram illustrating specific notification modes based on the notification processing when transitioning from manual driving to remote driving.

At step S120 in FIG. 5, the CPU 20A determines whether or not the notification flag is set to ON based on information acquired from the notification section 260. Processing proceeds to step S121 in cases in which determination is made that the notification flag is ON. The notification processing is ended (notification is ended) in cases in which determination is made that the notification flag is not ON (namely, the notification flag is OFF).

At step S121 in FIG. 5, the CPU 20A determines whether or not the given vehicle 12 is in the transitional state. Namely, the CPU 20A determines whether or not transition processing is being executed by the given vehicle 12. Processing proceeds to step S122 in cases in which determination is made that the given vehicle 12 is in the transitional state. Processing proceeds to step S123 in cases in which determination is made that the given vehicle 12 is not in the transitional state.

At step S122, the CPU 20A notifies the vehicle occupant that the given vehicle 12 is currently in the transitional state. Specifically, based on the information output from the notification section 260, while in the transitional state the notification unit 32 is operated and information relating to the transitional state is also transmitted to the other vehicle 14 using the inter-vehicle communication N2. Processing returns to step S120 after the CPU 20A has performed notification of the transitional state at step S122.

Note that as illustrated in FIG. 6, as a notification mode for the transitional state, the display light 32A flashes in red so as to prompt the occupant to exercise caution. Since the transitional state is classed as an important state from the perspective of safety, the notification mode employed therefor draws the attention of the occupant more strongly than those employed in notification of the respective driving states, as described later. When notifying of the transitional state, notification may be performed by audio data or a text display using the display 32B or the speaker 32C instead of, or as well as, notification using the display light 32A described above.

At step S123, the CPU 20A determines whether or not the current driving state of the given vehicle 12 is manual driving. Processing proceeds to step S124 in cases in which determination is made that the driving state is manual driving. Processing proceeds to step S125 in cases in which determination is made that the driving state is not manual driving.

At step S124, the CPU 20A notifies the vehicle occupant that the current driving state of the given vehicle 12 is manual driving, and also transmits information relating to the driving state of the given vehicle 12 to the other vehicle 14. As illustrated in FIG. 6, the display light 32A is lit up in yellow as an in-vehicle notification mode for manual driving. The CPU 20A returns to step S120 after notifying of manual driving at step S124.

At step S125, the CPU 20A determines whether or not the current driving state of the given vehicle 12 is autonomous driving. Processing proceeds to step S126 in cases in which determination is made that the current driving state is autonomous driving. Processing proceeds to step S127 in cases in which determination is made that the current driving state is not autonomous driving.

At step S126, the CPU 20A notifies the vehicle occupant that the current driving state of the given vehicle 12 is autonomous driving, and also transmits information relating to the driving state of the given vehicle 12 to the other vehicle 14. As an example, the display light 32A is lit up in blue as an in-vehicle notification mode for autonomous driving. The CPU 20A returns to step S120 after notifying of autonomous driving at step S126.

At step S127, the CPU 20A notifies the vehicle occupant that the current driving state of the given vehicle 12 is remote driving, and also transmits information relating to the driving state of the given vehicle 12 to the other vehicle 14. As illustrated in FIG. 6, the display light 32A is lit up in green as an in-vehicle notification mode for remote driving.

Operation and Advantageous Effects

The vehicle controller device 20 of the present exemplary embodiment is capable of implementing manual driving based on operation by the occupant of the given vehicle 12, autonomous driving in which the given vehicle 12 travels independently, and remote driving by the operation device. In the notification processing described above, the vehicle controller device 20 outputs information relating to these driving states, as well as to the transitional state relating to a transition from one driving state to another driving state, to the notification unit 32. This enables the notification unit 32 to notify the vehicle occupant of information relating to the respective driving states and the transitional state.

Moreover, in the present exemplary embodiment, at the start of transition processing, notification of the driving state is switched to notification of the transitional state. This enables the fact that the driving state of the given vehicle 12 is going to switch to a post-transition driving state to be clearly conveyed to the occupant. The vehicle controller device 20 is thereby able to utilize the notification unit 32 to prompt the occupant to take care during the transition between driving states.

In the present exemplary embodiment, a different notification mode is used for notification of each of the driving states and the transitional state. For example, in the present exemplary embodiment, notification of the transitional state, this being an important state from the perspective of travel safety, is performed using a notification mode that draws the attention of the occupant or the vehicle surroundings more strongly than the other notification modes. This enables the occupant to be prompted to exercise appropriate caution, and is thus capable of improving public traffic safety.

In the present exemplary embodiment, the notification unit 32 can perform notification in response to a request given by the occupant operating the operation section to switch the notification flag ON or OFF. For example, in the case of a travel plan in which a destination will be reached by autonomous driving and remote driving alone, the occupant is able to prioritize relaxation inside the vehicle by setting the notification flag to OFF. However, in cases in which a transition to manual driving is required during travel, the occupant is able to prioritize improved safety during transition by setting the notification flag to ON. In this manner, the occupant is notified of information relating to the respective driving states and the transitional state as and when it is necessary to do so, thereby enabling both safety and relaxation during travel to be improved.

In the present exemplary embodiment, information relating to the driving state or transitional state can be transmitted to the other vehicle 14 using the inter-vehicle communication N2, thereby enabling the other vehicle 14 to be notified of information relating to the respective driving states and the transitional state. This can for example prompt the other vehicle 14 to take care when the given vehicle 12 is in the transitional state, such as by refraining from cutting in front or overtaking.

### Modified Examples

Although not illustrated in the drawings, in the present exemplary embodiment a modified example may be applied in which the notification unit 32 of the first exemplary embodiment is installed so as to face outward from the given vehicle 12. In this modified example, the driving state or transitional state can be notified toward the exterior of the given vehicle 12 using the notification unit 32. A notification unit provided so as to face outward from the given vehicle 12 may be configured by mounting the display light 32A to the exterior of the vehicle body. Alternatively, the notification unit may be configured by providing the display 32B or speaker 32C on the vehicle body surface. Alternatively, a known daytime running lamp may be applied as the display light 32A.

Varying the color and illumination type when notifying using the display light 32A enables pedestrians and so on outside the given vehicle 12 to perceive the respective driving states and the transitional state of the given vehicle 12. Moreover, the other vehicle 14 traveling in the vicinity of the given vehicle 12 is able to perceive the illumination type of the display light 32A based on an image captured by a vehicle-mounted camera. This enables the given vehicle 12 to notify the other vehicle 14 of information relating to the driving state or transitional state using a simple configuration without using the inter-vehicle communication N2.

When notifying using the display light 32A, instead of, or in addition to modes in which the color of the display light 32A is changed, modes may be applied in which the illumination direction of the display light 32A is changed according to the respective states. The illumination direction may be changed so as to notify of an appropriate inter-vehicle distance between the given vehicle 12 and the other vehicle 14. For example, the display light 32A may be shone toward a spot on the road surface to indicate an appropriate inter-vehicle distance in the surroundings, thereby prompting by the given vehicle 12 and the other vehicle 14 to take care during travel.

When notifying using the display 32B, text or an icon may be displayed on the vehicle body to enable the respective driving states and the transitional state to be perceived from outside the given vehicle 12. When notifying using the speaker 32C, audio data output through the speaker 32C may be varied to enable the respective driving states and the transitional state from to be perceived from outside the given vehicle 12. As an alternative, a scent-emitting device that emits predetermined scents toward the exterior of the given vehicle 12 may be applied as a notification unit.

Using such configurations, information relating to the driving states and the transitional state is notified in perceptible modes through the notification unit 32 provided facing outward from the vehicle. This enables information relating to the driving states and the transitional state to be notified to the other vehicle 14 and pedestrians.

### Second Exemplary Embodiment

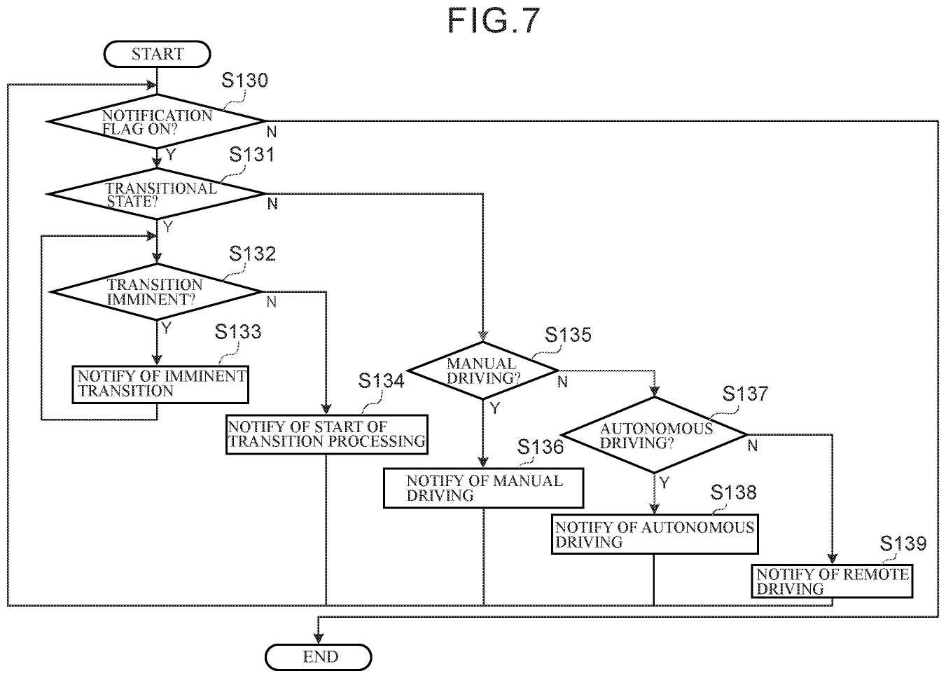

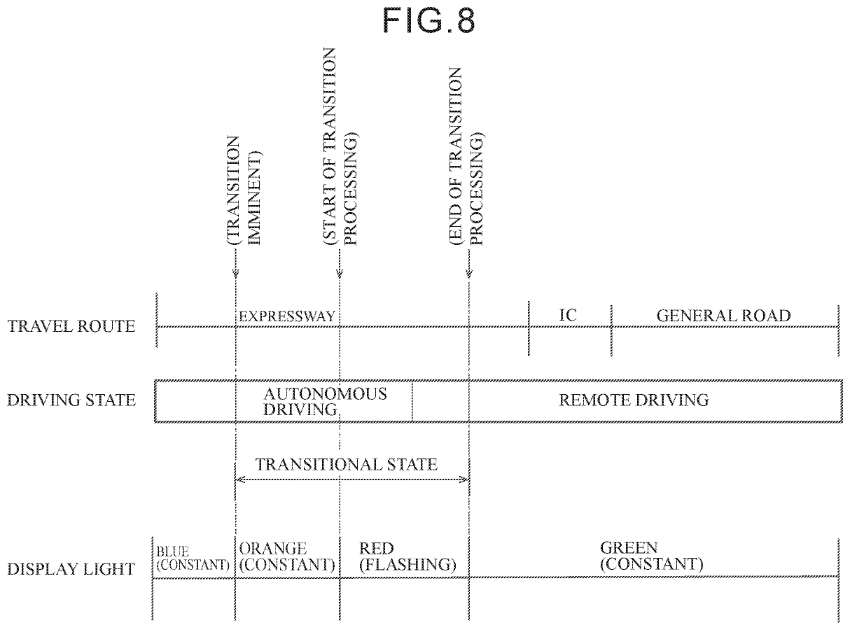

Explanation follows regarding a second exemplary embodiment of the present disclosure, with reference to FIG. 7 and FIG. 8. Note that sections with similar configuration to those in the first exemplary embodiment described above are allocated the same reference numerals, and explanation thereof is omitted.

The second exemplary embodiment differs from the first exemplary embodiment in the respect that the transitional state of the given vehicle 12 includes a period of time spanning from when a transition from one driving state to another driving state becomes imminent to the start of this transition. Namely, in cases in which a transition between driving states is scheduled, the transitional state corresponds to a period of time spanning from when the transition between driving states becomes imminent until the end of the transition processing. Thus, in addition to a period of time spanning between the start and the end of transition processing, the period of time spanning from when the transition between driving states becomes imminent to the start of transition processing is also notified to the occupant as the transitional state.

Explanation follows regarding a flow of notification processing of the second exemplary embodiment, with reference to the flowchart in FIG. 7 and the schematic diagram in FIG. 8. Note that FIG. 8 illustrates a case of a notification mode based on the notification processing for a travel plan in which the given vehicle 12 transitions from autonomous driving to remote driving just before an interchange (IC) when leaving an expressway and passing through the IC to join a general road.

At step S130 in FIG. 7, the CPU 20A determines whether or not the notification flag is set to ON based on information acquired from the notification section 260. Processing proceeds to step S131 in cases in which determination is made that the notification flag is ON. The processing is ended (notification is ended) in cases in which determination is made that the notification flag is not ON (namely, the notification flag is OFF).

At step S131, the CPU 20A determines whether or not the given vehicle 12 is in the transitional state based on information acquired from the travel plan generation section 230 and the travel control section 250. Processing proceeds to step S132 in cases in which determination is made that the given vehicle 12 is in the transitional state. Processing proceeds to step S135 in cases in which determination is made that the given vehicle 12 is not in the transitional state.

More detailed explanation follows regarding determination of the transitional state. The CPU 20A sets a target location where the transition processing is to start on a travel route to a destination, and computes an expected time at which the given vehicle 12 will pass through this target location. The CPU 20A then computes a location through which the given vehicle 12 will pass at a set duration prior to the expected time for passing through the target location, and sets this location as a transition imminent location. As illustrated in FIG. 8, in the present exemplary embodiment, the transition imminent location and the target location are set at locations positioned slightly ahead of the IC.

The CPU 20A acquires the current position of the given vehicle 12 using the position acquisition section 200, and determines the given vehicle 12 to be in the transitional state based on a condition of the given vehicle 12 having passed through the transition imminent location.

At step S132, the CPU 20A determines whether or not the transition from one driving state to another driving state is imminent based on the information acquired from the travel control section 250. Processing proceeds to step S133 in cases in which determination is made that the transition is imminent. Processing proceeds to step S134 in cases in which determination is made that the transition is not imminent.

In the present exemplary embodiment, in cases in which the current position of the given vehicle 12 is a position between the transition imminent location and the target location, the CPU 20A judges that transition processing has not yet started, and determines transition to be imminent. In cases in which the given vehicle 12 has passed through the target location, the transition processing has already started, and so transition is determined not to be imminent.

At step S133, the CPU 20A notifies the vehicle occupant that the given vehicle 12 will soon transition between driving states. Specifically, as illustrated in FIG. 8, notification is performed using a mode in which the display light 32A of the notification unit 32 is lit up in orange. The CPU 20A then returns to step S132.

When determination is made that the transition is not imminent and processing proceeds to step S134, the CPU 20A notifies the vehicle occupant that transition processing of the given vehicle 12 has now started, and transmits information relating to the start of transition processing by the given vehicle 12 to the other vehicle 14. As illustrated in FIG. 8, the occupant is notified using a mode in which the display light 32A flashes in red. The CPU 20A then returns to step S130 and repeats the processing.

When determination is made that the given vehicle 12 is not in the transitional state and processing proceeds to step S135, the CPU 20A determines whether or not the current driving state of the given vehicle 12 is manual driving. Processing proceeds to step S136 in cases in which determination is made that the current driving state is manual driving. Processing proceeds to step S137 in cases in which determination is made that the current driving state is not manual driving.

At step S136, the CPU 20A lights up the display light 32A in yellow so as to notify the vehicle occupant that the given vehicle 12 is traveling by manual driving. The CPU 20A also transmits information relating to the driving state of the given vehicle 12 to the other vehicle 14. The CPU 20A then returns to step S130.

At step S137, the CPU 20A determines whether or not the current driving state of the given vehicle 12 is autonomous driving. Processing proceeds to step S138 in cases in which determination is made that the current driving state is autonomous driving. Processing proceeds to step S139 in cases in which determination is made that the current driving state is not autonomous driving.

At step S138, the CPU 20A lights up the display light 32A in blue (see FIG. 8) so as to notify the vehicle occupant that the given vehicle 12 is traveling by autonomous driving. The CPU 20A also transmits information relating to the driving state of the given vehicle 12 to the other vehicle 14. The CPU 20A then returns to step S130.

At step S139, the CPU 20A lights up the display light 32A in green (see FIG. 8) so as to notify the vehicle occupant that the given vehicle 12 is traveling by remote driving. The CPU 20A also transmits information relating to the driving state of the given vehicle 12 to the other vehicle 14. The CPU 20A then returns to step S130.

Operation and Advantageous Effects

In the notification processing of the present exemplary embodiment, in cases in which a transition between driving states is scheduled in advance, a switch is made from notifying of the driving state to notifying of the transitional state when the transition becomes imminent. Specifically, in cases in which travel in a predetermined driving state is scheduled for a segment of the travel route of the given vehicle 12 to its destination, advance notification of this forthcoming driving state transition can be performed. This enables the occupant to be prompted to take care from an early stage, thus improving safety during travel.

### ADDITIONAL EXPLANATION

The processing executed by the CPU 20A reading software (a program), and the processing executed by the CPU 40A reading software (a program) in the exemplary embodiments and modified examples described above may be executed by various processors other than CPUs. Examples of such processors include programmable logic devices (PLDs) such as field-programmable gate arrays (FPGAs) that have a circuit configuration that can be modified following manufacture, or dedicated electrical circuits, these being processors such as application specific integrated circuits (ASICs) that have a custom designed circuit configuration to execute specific processing. The transition processing and the notification processing may be executed by one of these processors, or may be executed by a combination of two or more processors of the same type or different types to each other (for example a combination of plural FPGAs, or a combination of a CPU and an FPGA). A more specific example of a hardware structure of these various processors is electric circuitry combining circuit elements such as semiconductor elements.

The exemplary embodiments described above describe a format in which the programs are stored (installed) in advance on a non-transitory computer-readable recording medium. For example, the execution program employed by the vehicle controller device 20 of each of the autonomous driving-enabled vehicles 11 is stored in advance in the ROM 20B. A processing program employed by the remote controller device 40 of the remote operation station 16 is stored in advance in the ROM 40B. However, there is no limitation thereto, and the respective programs may be provided in a format recorded on a non-transitory recording medium such as compact disc read only memory (CD-ROM), digital versatile disc read only memory (DVD-ROM), or universal serial bus (USB) memory. Alternatively, the respective programs may be configured in a format for download from an external device through a network.

The flows of processing in the exemplary embodiments described above are given as examples, and unnecessary steps may be omitted, new steps added, and the processing sequences rearranged within a range not departing from the spirit thereof.

What is claimed is:

1. A vehicle controller device, comprising:
a communication section configured to receive operation information for operating a vehicle, from an operation device external to the vehicle;
a memory; and
a processor that is connected to the memory, the processor being configured to:
acquire peripheral information regarding a periphery of the vehicle from a peripheral information detection section,
generate a travel plan for the vehicle based on the peripheral information,
control autonomous driving in which the vehicle travels in accordance with the travel plan, and control remote driving in which the vehicle travels in accordance with the operation information received by the communication section, and
output information relating to a driving state corresponding to manual driving by operation by an occupant of the vehicle, the autonomous driving, or the remote driving, and information relating to a transitional state corresponding to a transition from one driving state to another driving state, to a notification unit configured to perform notification of the driving state and the transitional state.

2. The vehicle controller device of claim 1, wherein:
the transitional state is a state corresponding to a period of time from a start to an end of control performed in the vehicle to transition from one driving state to another driving state; and
the notification unit is configured to switch from performing notification of the driving state to performing notification of the transitional state in conjunction with commencement of the control of the transition.

3. The vehicle controller device of claim 1, wherein:
in a case in which a transition from one driving state to another driving state is scheduled, the transitional state includes a period of time from when the transition from the one driving state to the other driving state becomes imminent until commencement of the transition; and
the notification unit is configured to switch from performing notification of the driving state to performing notification of the transitional state when the transition has become imminent.

4. The vehicle controller device of claim 1, wherein the notification unit is configured to perform notification of the driving state and the transitional state using mutually different notification modes.

5. The vehicle controller device of claim 1, wherein the notification unit is provided inside the vehicle, and is configured to perform notification of the driving state and the transitional state in response to a request by an occupant inside the vehicle.

6. The vehicle controller device of claim 1, wherein the notification unit is provided facing outward from the vehicle, and is configured to perform notification of the driving state and the transitional state in a manner enabling another vehicle or person to perceive the driving state and the transitional state.

7. The vehicle controller device of claim 1, wherein the communication section is configured to transmit information relating to the driving state or the transitional state to another vehicle in a peripheral area of the vehicle.
